(19) United States
(12) Patent Application Publication
(10) Pub. No.: US 2018/0048414 A1
(43) Pub. Date: Feb. 15, 2018

(54) DISCOVERING PHYSICAL CELL IDENTIFICATION IN A SUB-BANDED SIGNAL IN A DISTRIBUTED BASE STATION

(71) Applicant: CommScope Technologies LLC, Hickory, NC (US)

(72) Inventors: Navin Srinivasan, Fairfax, VA (US); Ariful Hannan, Sterling, VA (US); Khalid W. Al-Mufti, Sterling, VA (US)

(21) Appl. No.: 15/673,799

(22) Filed: Aug. 10, 2017

Related U.S. Application Data
(60) Provisional application No. 62/373,462, filed on Aug. 11, 2016.

(51) Int. Cl. H04J 11/00; H04W 72/04; H04W 48/16; H04W 56/00

(52) U.S. Cl. CPC H04J 11/0079; H04W 56/001; H04W 72/0453; H04W 48/16; H04W 72/0406; H04J 11/005; H04W 74/08

(57) ABSTRACT

A method for detecting a physical cell identification (PCI) for a wireless coverage area is provided. The method includes establishing a hypothesis having a set of values including a number of subbands, a set of synchronization sequences, and a frequency offset; iteratively updating and testing the set of values against extracted baseband data until a current set of values results in frame synchronization; and decoding the physical cell identification based on the set of values that resulted in frame synchronization.

### CROSS-REFERENCE TO RELATED APPLICATIONS

This application claims the benefit of U.S. Provisional Application Ser. No. 62/373,462, filed Aug. 11, 2016, the contents of all of which are hereby incorporated by reference.

### BACKGROUND

The traditional monolithic RF base transceiver station (BTS) architecture is increasingly being replaced by a distributed BTS architecture in which the functions of the BTS are separated into two physically separate units—a baseband unit (BBU) and a remote radio head (RRH). The BBU performs baseband processing for the particular air interface that is being used to wirelessly communicate over the RF channel. The RRH performs radio frequency processing to convert baseband data output from the BBU to radio frequency signals for radiating from one or more antennas coupled to the RRH and to produce baseband data for the BBU from radio frequency signals that are received at the RRH via one or more antennas.

The RRH is typically installed near the BTS antennas, often at the top of a tower, and the BBU is typically installed in a more accessible location, often at the bottom of the tower. The BBU and the RRH are typically connected through one or more fiber optic links. The interface between the BBU and the RRH is defined by front-haul communication link standards such as the Common Public Radio Interface (CPRI) family of specifications, the Open Base Station Architecture Initiative (OBSAI) family of specifications, and the Open Radio Interface (ORI) family of specifications.

The specifications for the various standards for the fiber optic link define a Control and Management Plane (C&M) and a User Plane. The C&M plane carries all the Control and Management/Maintenance data and the User Plane carries the IQ data for the user traffic. The standards provide the guidelines for the data format that needs to be followed when sending baseband IQ data on the fiber optic link. However, the standards do allow some proprietary features to be included in compliant systems. For example, some manufacturers may use a proprietary format for generating the baseband data. One such technique that is allowed under the standard, but not required, is so-called “sub-banding.” This is a technique in which a frequency band, e.g. a 10 MHz channel, defined by the standard is broken down in a proprietary way and carried between the BBU and the RRH using 2 or more sub-bands in the assigned channel, e.g., 2 sub-bands of 5 MHz each are used in place of a single 10 MHz channel.

Testing equipment is being developed by third party vendors to test these distributed base stations. To be able to test the distributed base station, the test equipment must be able to recognize the signals on the optical link between the BBU and RRH, e.g., the test equipment needs to be able to detect the Physical Cell Identification (PCI) for the wireless coverage area or cell being tested. This is difficult when proprietary formats are used in the communications carried by the distributed base station. Therefore, a test system and method are needed that can detect the presence of proprietary data formats, such as sub-banding, when attempting to test a distributed base station.

### DRAWINGS

FIG. 1 is a block diagram of one exemplary embodiment of tester for a distributed base station system within which the techniques for extracting a physical cell identification (PCI) for a subbanded wireless coverage area described here can be used.

FIG. 2 is a flow diagram of one exemplary embodiment of a method of extracting a physical cell identification (PCI) in a distributed base station having subbanded wireless coverage area.

FIGS. 3A-3C are spectrum diagrams that illustrates an example of a 10 MHz channel and a 20 MHz channel in a distributed base station with synchronization signals.

FIG. 4 illustrates an example subbanding scheme for a 10 MHz channel including placement of the synchronization signals in the two subbands.

FIG. 5 is a timing diagram that illustrates a stream of data for the subbanding scheme of FIG. 4.

FIG. 6 illustrates a subbanding scheme for a 20 MHz channel including placement of the synchronization signals in the two of the four subbands.

FIG. 7 is a timing diagram that illustrates a stream of data for the subbanding scheme of FIG. 6.

FIG. 8 is a flow diagram of one exemplary embodiment of a method for extracting a physical cell identification (PCI) in a distributed base station having subbanded channels.

### DETAILED DESCRIPTION

Embodiments of the present invention enable operators to test a distributed base station using the Common Public Radio Interface (CPRI) link between the baseband unit (BBU) and the remote radio head (RRH) even when a proprietary scheme is used to divide the baseband IQ data for a wireless coverage area or cell into a number of subbands. Embodiments of the present invention establish a hypothesis as to the number of subbands and other characteristics for the wireless coverage area. Then, the hypothesis is iteratively tested and updated against baseband data in the link between the BBU and the RRH until frame synchronization is achieved. Once frame synchronization is achieved, the physical cell identification (PCI) can be decoded and other tests completed on the cell.

This detailed description discloses a distributed base station and its interface to a tester that detects a physical cell identification (PCI) for a subbanded cell. Further, the detailed description also discloses embodiments of a methodology for the tester to identify the subbanded nature of the cell and for extracting the PCI. Finally, the detailed description provides a discussion of embodiments of the tester that embodies the teachings of the present invention.

### Distributed Base Station System

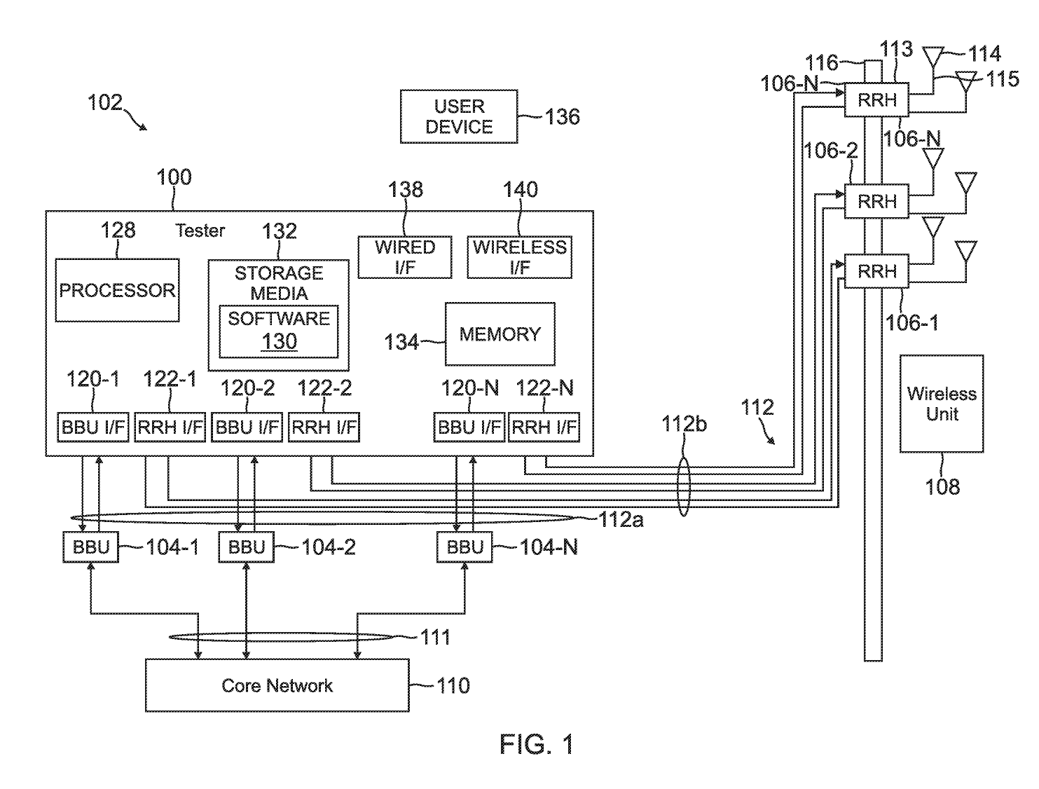

FIG. 1 is a block diagram of one exemplary embodiment of a tester 100 for a distributed base station system, indicated generally at 102. In the exemplary embodiment shown in FIG. 1, the system 102 comprises a plurality of baseband units (BBU) 104-1 to 104-N and a plurality of remote radio heads (RRH) 106-1 to 106-N that communicate over a plurality of wireless radio frequency (RF) channels with one or more wireless units 108 (such as mobile telephones, smartphones, tablets, wireless modems for laptops or other computers or for other devices such as wireless sensors or other “Internet of Things” (IOT) or machine-to-machine (M2M) devices) using one or more standard wireless air interfaces. The exemplary embodiment of system 102 shown in FIG. 1 may support several air interfaces, e.g., three air interfaces including, but not limited to, Long-Term Evolution (LTE) 4G air interface described in the “Third Generation Partnership Project (3GPP) Technical Specification (TS) 36.211 Evolved Universal Terrestrial Radio Access (E-UTRA); Physical Channels and Modulation” specification produced by the 3GPP, Advanced Wireless Services (AWS-1), Personal Communications Services (PCS), CLR, GSM, WiMax, and others. It is to be understood that other air interfaces can be used.

Each BBU 104 is communicatively coupled to the core network 110 of a wireless service provider using a suitable bi-directional backhaul communication link 111 and interface (for example, using a wireless or wired ETHERNET connection and using the LTE S1 interface). The backhaul communication link 111 can also be used for base station-to-base station communications using the LTE X2 interface.

Each BBU 104 is communicatively coupled to a corresponding RRH 106 using a bi-directional front-haul communication link 112. In the exemplary embodiment shown in FIG. 1, the bi-directional front-haul communication link 112 is implemented using a plurality of pairs of optical fibers, where, in each pair, one optical fiber is used for downlink communications from the BBU 104 to the RRH 106 and the other optical fiber is used for uplink communications from the RRH 106 to the BBU 104. Further, as shown in FIG. 1, the bi-directional communication link 112 are split into two parts to allow a tester 100 (described in more detail below) to be inserted between the BBUs 104 and the RRHs 106. Namely, the bi-directional communication link 112 include a first part 112a connecting BBU 104 to tester 100 and a second part 112b connecting tester 100 to a respective RRH 106. It is to be understood that the front-haul communication link 112 can be implemented in other ways. The exemplary embodiment shown in FIG. 1 is described here as using a CPRI interface for communications between each BBU 104 and the corresponding RRH 106 over the front-haul communication link 112. It is to be understood, however, that a different front-haul interface could be used (for example, the OBSAI or ORI interface).

As noted above, each BBU 104 performs baseband processing for the particular air interface that is being used to wirelessly communicate over its assigned RF channel, and the RRH 106 performs radio frequency processing to convert baseband data output from the BBU 104 to radio frequency signals for radiating from one or more antennas 114 that are connected to the RRH 106 at antenna port 113 via coaxial cable 115 and to produce baseband data for the associated BBU 104 from radio frequency signals that are received at the RRH 106 via one or more antennas 114.

During normal operation of the system 102, in the downlink direction, the BBUs 104 generate downlink baseband IQ data to encode frames of downlink user and control information received from the core network for communication to the wireless units 108 over the appropriate wireless RF channels. The downlink baseband IQ data is communicated from the BBUs 104 to the RRHs 106 over the respective front-haul communication link 112. The RRHs 106 receive the downlink baseband IQ data and generate one or more downlink analog radio frequency signals that are radiated from the one or more antennas 114 for reception by the wireless units 108. The wireless units 108 perform baseband processing, in accordance with the air interface, on the received downlink analog RF downlink signals in order to recover the frames of downlink user and control information.

During normal operation of the system 102, in the uplink direction, the wireless units 108 generate, in accordance with the air interface, uplink analog radio frequency signals that encode uplink user and control information that is to be communicated to the core network 110 and transmits the generated uplink analog RF signals over the wireless RF channel. The uplink analog RF signals are received by one or more antennas 114 connected to the RRHs 106. The RRH 106 that receives the uplink analog RF signal produces uplink baseband IQ data from the received uplink analog RF signals. The uplink baseband IQ data is communicated from the RRH 106 to the associated BBU 104 over the front-haul communication link 112. The BBU 104 receives the uplink baseband IQ data and performs baseband processing, in accordance with the air interface, on the uplink baseband IQ data in order to recover the uplink user and control information transmitted from the wireless units 108. The BBU 104 communicates the recovered uplink user and control information to the core network 110 over the backhaul communication link 111 using the backhaul interface.

The RRHs 106 are typically installed remotely from its corresponding BBU 104, near the antennas 114 and is mounted to a structure 116 (such as a tower, pole, building, tree, or other structure). For example, the RRH 104 can be mounted near the top of the structure 116 and the BBU 104 can be located on the ground, where the optical fibers used to implement the front-haul communication link 112 run up the structure 116 to couple the BBU 104 to the RRU 106. Although FIG. 1 shows the RRH 106 mounted near the top of structure 116, the RRH 106 can be mounted at other positions relative to the structure 116, for example, approximately midway between the bottom and top of the structure 116.

### Subbands

In some distributed base stations, the baseband IQ data for a physical cell or wireless coverage area is divided into multiple subbands. In an LTE system, these subbands are implemented using a proprietary technique known to the equipment manufacturer. Unfortunately, this information is not typically known to the manufacturer of test equipment that is used by a service provider to test the distributed base station and thus makes it difficult to decode the physical cell identification (PCI) of the cell or to perform any testing on the distributed base station and the physical cell. Thus, the present application describes a technique that enables testing of a distributed base station by detecting the structure of the subbanding used in the distributed base station by analyzing the baseband data sent between the BBU 104 and the RRH 106. The technique further enables decoding of the physical cell identification without prior knowledge of the subband structure of the cell.

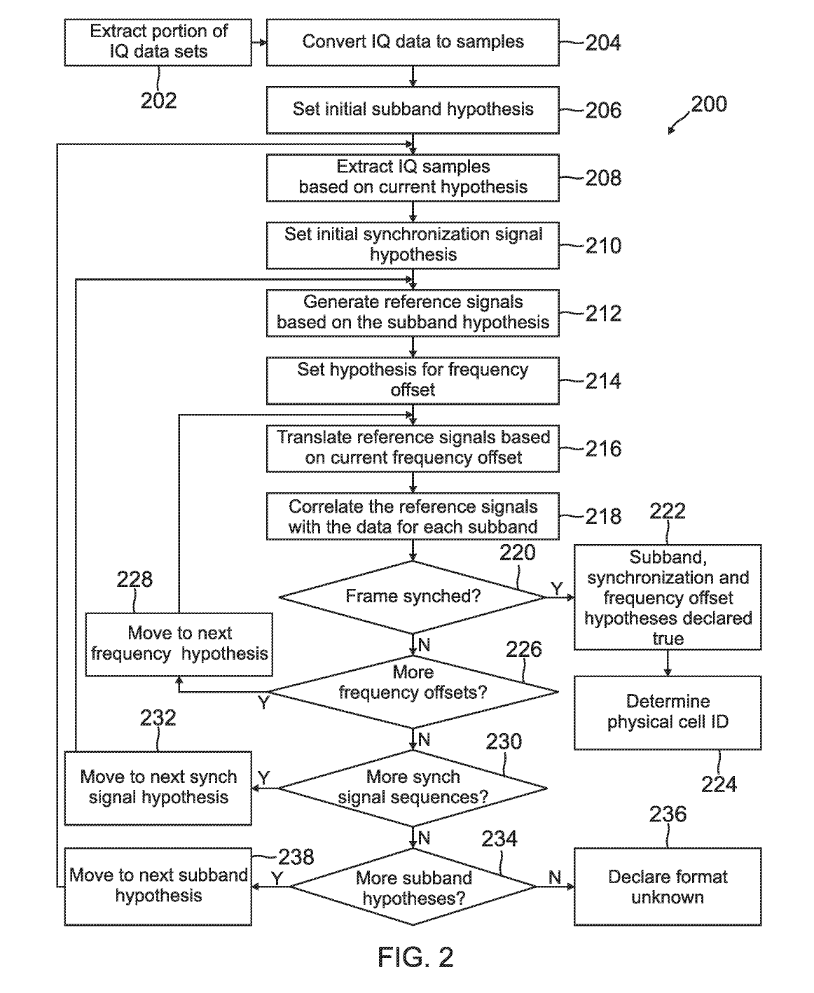

FIG. 2 is a flow chart that illustrates a method for determining the physical cell identification of a cell when subbands have been implemented in the distributed base station. This method is implemented if the physical cell identification (PCI) cannot be decoded from the CPRI data stream between the BBU 104 and the RRH 106 under the assumption that there is no subbanding. This inability to directly detect the PCI is an indication that subbanding may in use in the distributed base station system 102. It is noted that the method as described below relates to a system 102 that implements the LTE air interface standard. Other embodiments of this method can be adapted to other air interface standards. As an initial matter, the nature of subbanding with an LTE air interface is described first.

Under the LTE standard, the LTE downlink has specific synchronization signals: Primary Synchronization Sequence (PSS) and the Secondary Synchronization Sequence (SSS) that are used by the User Equipment (UE) for determining the LTE symbol timing. The downlink also has an “always on” Broadcast Channel (BCH) that provides the UE information as part of the Master Information Block (MIB) related to the downlink transmission bandwidth of the LTE cell and the system frame number.

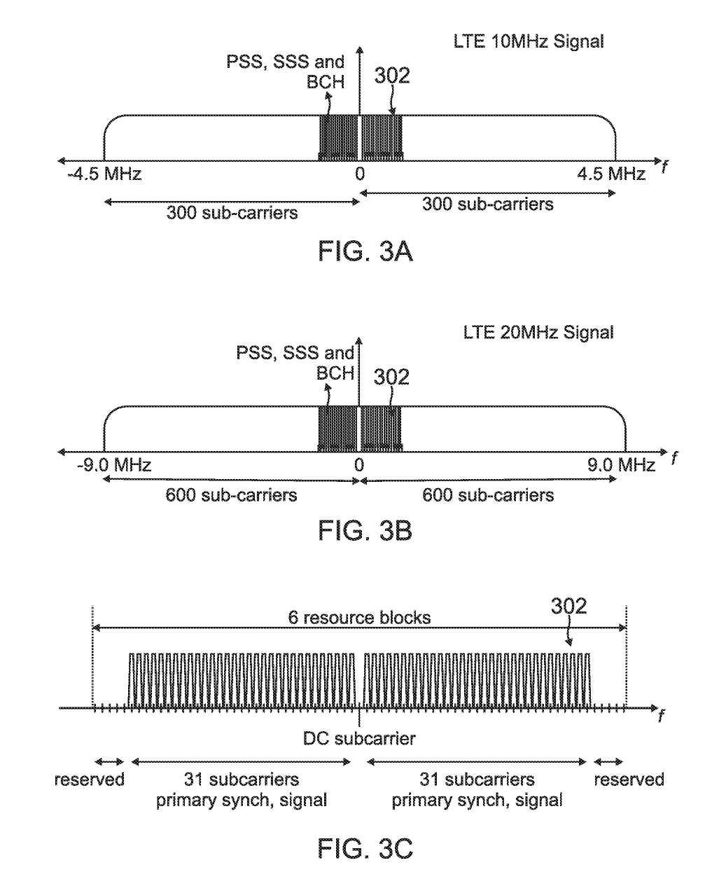

The Synchronization signals (PSS and SSS) are generated from a defined set of sequences, which can be exploited to detect if the baseband IQ data is sub-banded or not on the front-haul communication link 112. As shown in FIG. 3A and FIG. 3B, the PSS, SSS and the BCH data occupy the center 6 Resource blocks 302 of the LTE signal, irrespective of the actual system bandwidth of the Cell. FIGS. 3A and 3B show the position of PSS, SSS and BCH in a 10 MHz band and a 20 MHz band, respectively. FIG. 3C shows the PSS sub-carriers. The SSS sub-carrier positioning is similar to that of the PSS subcarriers.

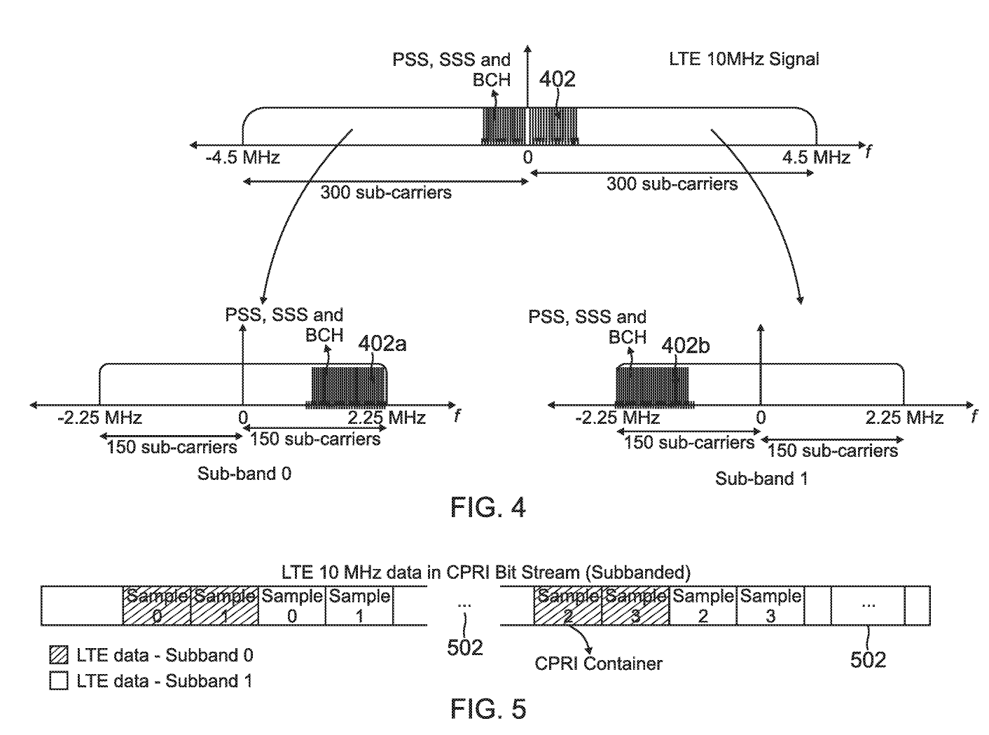

In some systems, the baseband data for a physical cell is implemented by subbanding the LTE downlink, e.g., a single band or channel is subdivided into two or more subbands or subchannels. FIG. 4 shows an example of subbanding of a 10 MHz LTE band or channel. In the 10 MHz channel, the synchronization signals PSS and SSS are indicated at 402. In this embodiment, the BBU 104 sub-bands the 10 MHz signal into two 5 MHz subbands before sending it out on the front-haul communication link 112. In this embodiment, the two subbands are shown translated in frequency such that the subbands are each centered on DC. With this subbanding and translation, the synchronization signals PSS and SSS are now divided and located at the edge of each of Subband 0 and Subband 1 as shown at 402a and 402b.

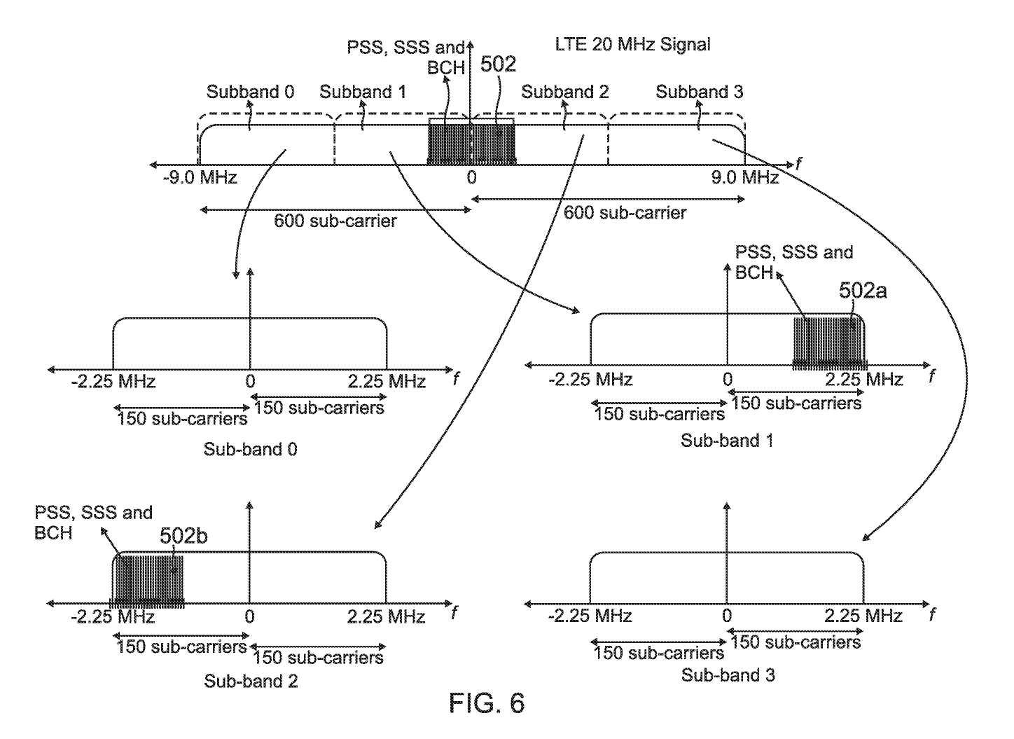

FIG. 5 shows one embodiment of the CPRI data format that is used on front-haul communication link 112 to carry the data for the two subbands of the baseband IQ data that is communicated from the BBU 104 to the RRH 106. In this embodiment, the CPRI data stream includes samples from Subband 0 interleaved with samples from Subband 1. Specifically, CPRI containers carrying data for two samples from Subband 0 are followed by CPRI containers carrying data for two samples from Subband 1 in a repeating pattern as illustrated. The gaps 502 in the data stream of FIG. 5 represent the actual gaps in the data stream, as per the CPRI format, between the successive samples for that particular signal. The gaps 502 could contain data samples for other LTE carriers that could be configured on the same link, and also the CPRI control plane data. FIG. 5 has been simplified by showing gaps 502 to illustrate the data format for a single cell when subbanding is used on the front-haul communication link 112 between the BBU 104 and the RRH 106.

FIG. 6 shows an example of sub-banding of a 20 MHz LTE band or channel. In the 10 MHz channel, the synchronization signals PSS and SSS are indicated at 502. In this embodiment, the BBU 104 sub-bands the 20 MHz signal into four 5 MHz subbands before sending it out on the front-haul communication link 112. In this embodiment, the four subbands are shown translated in frequency such that the subbands are each centered on DC. With this subbanding and translation, the synchronization signals PSS and SSS are now divided and located at the edge of each of Subband 1 and Subband 2 as shown at 502a and 502b. Subband 0 and Subband 3 do not contain any portion of the synchronization signals.

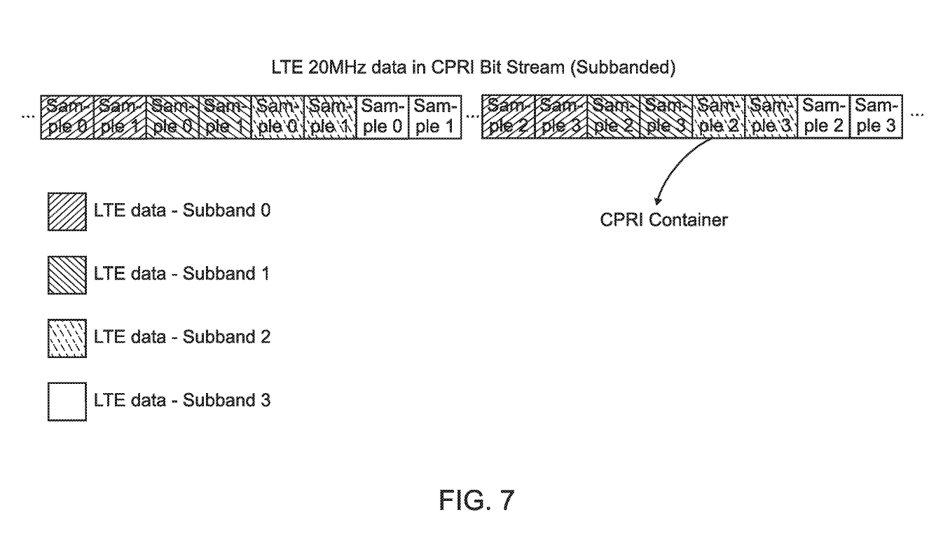

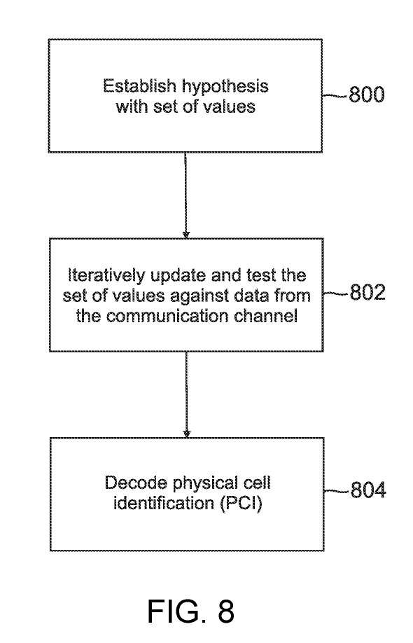

FIG. 7 shows one embodiment of the CPRI data format that is used on front-haul communication link 112 to carry the data for the four subbands from the BBU 104 to the RRH 106. In this embodiment, the CPRI data stream includes interleaved samples from Subband 0, Subband 1, Subband 2, and Subband 3. Specifically, CPRI containers carrying data for two samples from each of Subband 0, Subband 1, Subband 2, Subband 3, respectively, are included in a sequential, repeating pattern as illustrated.

The method begins at block 202 by extracting a portion of the IQ data sets transmitted on the front-haul communication link 112 between the BBU and the RRH. The extracted IQ data sets are converted to samples at block 204. The data sent on the front-haul communication link 112 is IQ bit stream with the I and Q bits interleaved. At block 204, the I and Q bits are de-interleaved and separated into I samples and Q samples.

At block 206, the method begins the process of establishing a hypothesis about the subbanding structure that can be detected by analyzing the baseband data on the front-haul communication link 112. There are three separate hypotheses that need to be tested to be able to verify the subbanding structure. These hypotheses include: (1) the number of subbands, (2) the synchronization sequences, and (3) the frequency offset. When this set of three values has been validated in a current hypothesis, then the subbanding structure has been determined and the physical cell identification (PCI) can be decoded.

To begin this process, the method sets the initial subband hypothesis at block 206. In one example, the method sets the initial hypothesis to two subbands. Based on this hypothesis, the method extracts IQ samples from the baseband data in the CPRI data stream for the subbands that contain portions of the synchronization signal under the current hypothesis on the number of subbands at block 208. For example, if the hypothesis is that a 10 MHz LTE channel is divided into two subbands (FIG. 4), samples are selected from the data stream shown in FIG. 5, e.g., the CPRI containers for Subband 0 and Subband 1 since both subbands contain a portion of the synchronization signals. Alternatively, if the current hypothesis is that a 20 MHz LTE channel is divided into four subbands (FIG. 6), samples are selected from the data stream shown in FIG. 7, e.g., the CPRI containers for Subband 1 and Subband 2.

The method proceeds to block 210 and sets the second value in the set of values: the initial synchronization sequence hypothesis. In the LTE standard, various options for the synchronization sequence are provided, e.g., sets of pre-defined symbols for use as PSS and SSS signals. At this point, an initial synchronization sequence is selected. At block 212, reference signals are generated in accordance with the subband hypothesis from the selected synchronization sequence.

The method proceeds to block 214 and sets the final value in the set of values in the hypothesis. This value is the frequency offset used by the BBU to center the subbands substantially on DC. As this value may be more or less than half of the bandwidth of the subband, an initial value is set here, e.g., 2.25 MHz for a 5 MHz subband. At block 216, the current reference signals are translated using the current frequency offset hypothesis.

At block 218, the current set of values in the hypothesis is tested against the data extracted from the front-haul communication link 112. In this test, the translated reference signals are correlated with the extracted data for the subbands that are expected to contain the synchronization signals.

At block 220, the method determines if the current hypothesis tests true. If the translated reference signals correlate with the extracted data from the subbands in the IQ data from the front-haul communication link 112, then frame synchronization is achieved. The current set of values (number of subbands, synchronization sequence, and the frequency offset) are declared to be true at 222 and the physical cell identification (PCI) is determined at block 224.

If frame synchronization is not achieved at block 220, then the method proceeds to block 226 and determines if there are additional options for the frequency offset that have not been tested with the current values for number of subbands and synchronization sequence. If so, the method proceeds to block 228 and moves to the next frequency offset and returns to block 216 to test the new set of values for the hypothesis.

If there are no additional frequency offsets at block 226, the method proceeds to block 230 and determines whether there are additional synchronization sequences that have not been tested for the number of subbands in the current hypothesis. If there are additional synchronization sequences, the method proceeds to block 232 and moves to the next synchronization signal. The method returns to block 212 to test the new set of values for the hypothesis.

If there are no additional synchronization sequences at block 230, the method proceeds to block 234 and determines if there are additional numbers of subbands that have not yet been tested. If so, the method proceeds to block 238 and moves to the next number of subbands in the hypothesis. The method returns to block 208 to test the new set of values in the hypothesis. If there are no additional numbers of subbands at block 234, the method proceeds to block 236 and declares that the format of the signal on the front-haul communication link 212 is not known.

An alternate embodiment of a process for determining a physical cell identification (PCI) in a system that implements subbanding on a front-haul communication link 212 between a BBU 104 and a RRH 106. In this embodiment, the process begins by establishing an initial hypothesis for a set of values that characterize the subbanding structure. In one embodiment, the set of values include: (1) the number of subbands, (2) the synchronization signals, and (3) the frequency offset. The method proceeds to iteratively test and update the set of values against data in the front-haul communication link until frame synchronization is achieved. When frame synchronization is achieved, the method decodes the PCI at block 804. Otherwise, if the method exhausts all combinations in the set of values without achieving frame synchronization, then the format of the front-haul communication link 112 is declared to be unknown.

### Tester

As shown in FIG. 1, tester 100 can be coupled to the font-haul communication link 112 in order to capture downlink and uplink frames of baseband data communicated between the plurality of BBUs 104 and the respective plurality of RRHs 106 while the plurality of BBUs 104 and the plurality of RRHs 106 are operating normally. This capturing of baseband data enables tester 100 to decode the physical cell identification (PCI) and perform other tests on the data exchanged between the BBUs 104 and the RRHs 106. In one embodiment, tester 100 uses the techniques discussed above in order to test systems that use a proprietary subbanding using baseband signals carried between the BBUs 104 and the RRHs 106.

A user can interact with the software 130 executing on the tester 100 using a user device 136, e.g., smartphone, tablet, or computer. The user device 136 is communicatively coupled to the tester 100. In the exemplary embodiment shown in FIG. 1, the tester 100 includes one or more wired interfaces 138 (for example, an ETHERNET interface and/or a USB interface) and wireless interfaces 140 (for example, a Wi-Fi wireless interface) to communicatively couple the tester 100 to a local area network or directly to the user device 136. Moreover, a remotely located user device 136 can access the tester 100 via a connection established over the local area network and/or a public network such as the Internet. In one embodiment, the software 130 implements a webserver that is operable to present a browser-based user interface that enables a user to use a general-purpose Internet browser installed on the user device 136 to interact with the software 130 on the tester 100.

Also, although the embodiments described above are described as using antenna carriers in downlink CPRI frames, it is to be understood that the techniques described here can be used with other streams of baseband IQ data (for example, streams of baseband IQ data communicated over an OBSAI or ORI interface).

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs) or Field Programmable Gate Arrays (FGPAs).

### Example Embodiments

Example 1 includes a method for detecting a physical cell identification (PCI) for a wireless coverage area, the method comprising: establishing a hypothesis having a set of values including a number of subbands, a set of synchronization sequences, and a frequency offset; iteratively updating and testing the set of values against extracted baseband data until a current set of values results in frame synchronization; and decoding the physical cell identification based on the set of values that resulted in frame synchronization.

Example 2 includes the method of Example 1, and further comprising extracting IQ samples from a front-haul communication link in a distributed base transceiver station to provide the extracted baseband data.

Example 3 includes the method of any of Examples 1-2, wherein extracting IQ samples comprises selecting IQ samples from CPRI containers based on the anticipated location of synchronization sequences for the current subband hypothesis.

Example 4 includes the method of any of Examples 1-3, wherein iteratively updating the values comprises: establishing a number of subbands; establishing a set of synchronization sequences; for a set of values for the number of subbands and the set of synchronization sequences, stepping through a set of frequency offset values.

Example 5 includes the method of Example 4, and further comprising, for a selected number of subbands, stepping through a number of sets of synchronization sequences.

Example 6 includes the method of Example 5, and further comprising stepping through a series of values for the number of subbands.

Example 7 includes the method of any of Examples 4-6, wherein establishing a set of synchronization sequences comprises selecting reference signals for Primary Synchronization Sequence (PSS) and Secondary Synchronization Sequence (SSS) symbols.

Example 8 includes the method of any of Examples 4-7, wherein testing the current set of values comprises: translating the current reference signals using the current frequency offset values; and correlating the translated reference signals with the extracted baseband data.

Example 9 includes the method of Example 8, wherein correlating the translated reference signals with the extracted baseband data comprises correlating the translated reference signals with the portion of the extracted baseband data corresponding to subbands expected to contain the synchronization sequences.

Example 10 includes the method of any of Examples 1-9, and further including declaring the format as unknown when no combination of number of subbands, sets of synchronization sequences and frequency offsets result in frame synchronization.

Example 11 includes a tester, comprising: at least one interface to communicatively couple the tester unit to a front-haul communication link used for communicating front-haul data to a remote radio head (RRH) having one or more antenna ports; a programmable processor, coupled to the interface, configured to execute software, wherein the software is operable to cause the tester to do the following: establish a hypothesis having a set of values including a number of subbands, a set of synchronization sequences, and a frequency offset; iteratively update and test the set of values against extracted baseband data until a current set of values results in frame synchronization; and decode the physical cell identification based on the set of values that resulted in frame synchronization.

Example 12 includes the tester of Example 11, wherein the software further causes the tester to extract IQ samples from a front-haul communication link in a distributed base transceiver station to provide the extracted baseband data.

Example 13 includes the tester of any of Examples 11-12, wherein iteratively update the values comprises: establish a number of subbands; establish a set of synchronization sequences; for a set of values for the number of subbands and the set of synchronization sequences, step through a set of frequency offset values.

Example 14 includes the tester of Example 13, and further comprising, for a selected number of subbands, step through a number of sets of synchronization sequences.

Example 15 includes the tester of Example 14, and further comprising step through a series of values for the number of subbands.

Example 16 includes the tester of any of Examples 13-15, wherein establish a set of synchronization sequences comprises select reference signals for Primary Synchronization Sequence (PSS) and Secondary Synchronization Sequence (SSS) symbols.

Example 17 includes the tester of any of Examples 13-16, wherein test the current set of values comprises: translate the current reference signals using the current frequency offset values; and correlate the translated reference signals with the extracted baseband data.

Example 18 includes the tester of Example 17, wherein correlate the translated reference signals with the extracted baseband data comprises correlate the translated reference signals with the portion of the extracted baseband data corresponding to subbands expected to contain the synchronization sequences.

Example 19 includes a method for identifying a physical cell identification (PCI) in a baseband signal of an optical interface, the method comprising: extracting baseband data from the optical interface; converting the baseband data to samples; iteratively testing a hypothesis for the number of subbands in the baseband signal starting with a single band and incrementally increasing the number of subbands if the current hypothesis test fails; when a hypothesis tests true, using the hypothesis to determine a physical cell ID.

Example 20 includes the method of Example 19, wherein iteratively testing a hypothesis comprises testing a hypothesis that includes: (1) a number of subbands, (2) a set of synchronization sequences, and (3) a frequency offset for the subbands.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

1. A method for detecting a physical cell identification (PCI) for a wireless coverage area, the method comprising:
establishing a hypothesis having a set of values including a number of subbands, a set of synchronization sequences, and a frequency offset;
iteratively updating and testing the set of values against extracted baseband data until a current set of values results in frame synchronization; and
decoding the physical cell identification based on the set of values that resulted in frame synchronization.

2. The method of claim 1, and further comprising extracting IQ samples from a front-haul communication link in a distributed base transceiver station to provide the extracted baseband data.

3. The method of claim 1, wherein extracting IQ samples comprises selecting IQ samples from CPRI containers based on the anticipated location of synchronization sequences for the current subband hypothesis.

4. The method of claim 1, wherein iteratively updating the values comprises:
establishing a number of subbands;
establishing a set of synchronization sequences;
for a set of values for the number of subbands and the set of synchronization sequences, stepping through a set of frequency offset values.

5. The method of claim 4, and further comprising, for a selected number of subbands, stepping through a number of sets of synchronization sequences.

6. The method of claim 5, and further comprising stepping through a series of values for the number of subbands.

7. The method of claim 4, wherein establishing a set of synchronization sequences comprises selecting reference signals for Primary Synchronization Sequence (PSS) and Secondary Synchronization Sequence (SSS) symbols.

8. The method of claim 4, wherein testing the current set of values comprises:
translating the current reference signals using the current frequency offset values; and
correlating the translated reference signals with the extracted baseband data.

9. The method of claim 8, wherein correlating the translated reference signals with the extracted baseband data comprises correlating the translated reference signals with the portion of the extracted baseband data corresponding to subbands expected to contain the synchronization sequences.

10. The method of claim 1, and further including declaring the format as unknown when no combination of number of subbands, sets of synchronization sequences and frequency offsets result in frame synchronization.

11. A tester, comprising:
at least one interface to communicatively couple the tester unit to a front-haul communication link used for communicating front-haul data to a remote radio head (RRH) having one or more antenna ports;
a programmable processor, coupled to the interface, configured to execute software, wherein the software is operable to cause the tester to do the following:
establish a hypothesis having a set of values including a number of subbands, a set of synchronization sequences, and a frequency offset;
iteratively update and test the set of values against extracted baseband data until a current set of values results in frame synchronization; and
decode the physical cell identification based on the set of values that resulted in frame synchronization.

12. The tester of claim 11, wherein the software further causes the tester to extract IQ samples from a front-haul communication link in a distributed base transceiver station to provide the extracted baseband data.

13. The tester of claim 11, wherein iteratively update the values comprises:
establish a number of subbands;
establish a set of synchronization sequences;
for a set of values for the number of subbands and the set of synchronization sequences, step through a set of frequency offset values.

14. The tester of claim 13, and further comprising, for a selected number of subbands, step through a number of sets of synchronization sequences.

15. The tester of claim 14, and further comprising step through a series of values for the number of subbands.

16. The tester of claim 13, wherein establish a set of synchronization sequences comprises select reference signals for Primary Synchronization Sequence (PSS) and Secondary Synchronization Sequence (SSS) symbols.

17. The tester of claim 13, wherein test the current set of values comprises:
translate the current reference signals using the current frequency offset values; and
correlate the translated reference signals with the extracted baseband data.

18. The tester of claim 17, wherein correlate the translated reference signals with the extracted baseband data comprises correlate the translated reference signals with the portion of the extracted baseband data corresponding to subbands expected to contain the synchronization sequences.

19. A method for identifying a physical cell identification (PCI) in a baseband signal of an optical interface, the method comprising:
extracting baseband data from the optical interface;
converting the baseband data to samples;
iteratively testing a hypothesis for the number of subbands in the baseband signal starting with a single band and incrementally increasing the number of subbands if the current hypothesis test fails;
when a hypothesis tests true, using the hypothesis to determine a physical cell ID.

20. The method of claim 19, wherein iteratively testing a hypothesis comprises testing a hypothesis that includes: (1) a number of subbands, (2) a set of synchronization sequences, and (3) a frequency offset for the subbands.
